(19) United States
(12) Patent Application Publication
(10) Pub. No.: US 2022/0113795 A1
(43) Pub. Date: Apr. 14, 2022

(54) DATA PROCESSING SYSTEM AND METHOD FOR IMAGE ENHANCEMENT

(71) Applicant: Sony Interactive Entertainment Inc., Tokyo (JP)

(72) Inventors: Michael Eder, London (GB); Philip Cockram, London (GB)

(73) Assignee: Sony Interactive Entertainment Inc., Tokyo (JP)

(21) Appl. No.: 17/488,730

(22) Filed: Sep. 29, 2021

(30) Foreign Application Priority Data
Oct. 9, 2020 (GB) 2016041.2

(51) Int. Cl. G06F 3/01; G06T 7/11; G06T 3/40

(52) U.S. Cl. CPC G06F 3/013; G06T 7/11; G06T 2207/30201; G06T 2207/10021; G06T 2207/20081; G06T 3/40

(57) ABSTRACT

An image processing method includes: inputting data representative of an image into a machine learning system, the machine learning system having been previously trained to predict a gaze position of viewers of images; obtaining a predicted gaze position from the machine learning system in response to the input data; performing predicted gaze position dependent image processing, the image processing producing at least a first region of the image corresponding to where a viewer is predicted to gaze, and a second region, with a first image quality of the first region being higher than a second image quality of the second region; and outputting the processed image.

### BACKGROUND OF THE INVENTION

### Field of the invention

The present disclosure relates to data processing systems and methods for image enhancement. In particular, the present disclosure relates to data processing systems and methods that use gaze data from gaze tracking systems and pixel values from image frames to obtain additional pixel values for enhancing the image frames.

### Description of the Prior Art

Gaze tracking systems are used to identify a location of a subject's gaze within an environment; in many cases, this location may be a position on a display screen that is being viewed by the subject. In a number of existing arrangements, this is performed using one or more inwards-facing cameras directed towards the subject's eye (or eyes) in order to determine a direction in which the eyes are oriented at any given time. Having identified the orientation of the eye, a gaze direction can be determined and a focal region may be determined as the intersection of the gaze direction of each eye.

One application for which gaze tracking is considered of particular use is that of use in head-mountable display units (HMDs). The use in HMDs may be of particular benefit owing to the close proximity of inward-facing cameras to the user's eyes, allowing the tracking to be performed much more accurately and precisely than in arrangements in which it is not possibly to provide the cameras with such proximity. It will be appreciated however that gaze tracking can also be applied for other mods of content delivery, such as standard TVs.

By utilising gaze detection techniques, it may be possible to provide a more efficient and/or effective processing method for generating content or interacting with devices.

For example, gaze tracking may be used to provide user inputs or to assist with such inputs—a continued gaze at a location may act as a selection, or a gaze towards a particular object accompanied by another input (such as a button press) may be considered as a suitable input. This may be more effective as an input method in some embodiments, particularly in those in which a controller is not provided or when a user has limited mobility.

Foveal rendering is an example of a use for the results of a gaze tracking process in order to improve the efficiency of a content generation process. Foveal rendering is rendering that is performed so as to exploit the fact that human vision is only able to identify high detail in a narrow region (the fovea), with the ability to discern detail tailing off sharply outside of this region.

In such methods, a portion of the display can be identified as being an area of focus in accordance with the user's gaze direction. This portion of the display can be supplied with high-quality image content, while the remaining areas of the display can be provided with lower-quality (and therefore less resource intensive to generate) image content. This can lead to a more efficient use of available processing resources without a noticeable degradation of image quality for the user.

It is therefore considered advantageous to be able to improve gaze tracking methods, and/or apply the results of such methods in an improved manner. It is in the context of such advantages that the present disclosure arises.

### SUMMARY OF THE INVENTION

Various aspects and features of the present invention are defined in the appended claims and within the text of the accompanying description.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an HMD worn by a user;

FIG. 2 is a schematic plan view of an HMD;

FIG. 3 schematically illustrates the formation of a virtual image by an HMD;

FIG. 4 schematically illustrates another type of display for use in an HMD;

FIG. 5 schematically illustrates a pair of stereoscopic images;

FIG. 6a schematically illustrates a plan view of an HMD;

FIG. 6b schematically illustrates a near-eye tracking arrangement;

FIG. 7 schematically illustrates a remote tracking arrangement;

FIG. 8 schematically illustrates a gaze tracking environment;

FIG. 9 schematically illustrates a gaze tracking system;

FIG. 10 schematically illustrates a human eye;

FIG. 11 schematically illustrates a graph of human visual acuity;

FIG. 12 schematically illustrates a data processing apparatus;

FIG. 13a schematically illustrates an example of a predicted image frame;

FIG. 13b schematically illustrates an example of another predicted image frame;

FIG. 14a schematically illustrates a graph of image resolution versus distance from a gaze point;

FIG. 14b schematically illustrates another graph of image resolution versus distance from a gaze point;

FIG. 15 schematically illustrates regions corresponding to predicted gaze positions on an image; and

FIG. 16 is a schematic flowchart illustrating a data processing method.

### DESCRIPTION OF THE EMBODIMENTS

Data processing systems and methods for image enhancement are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

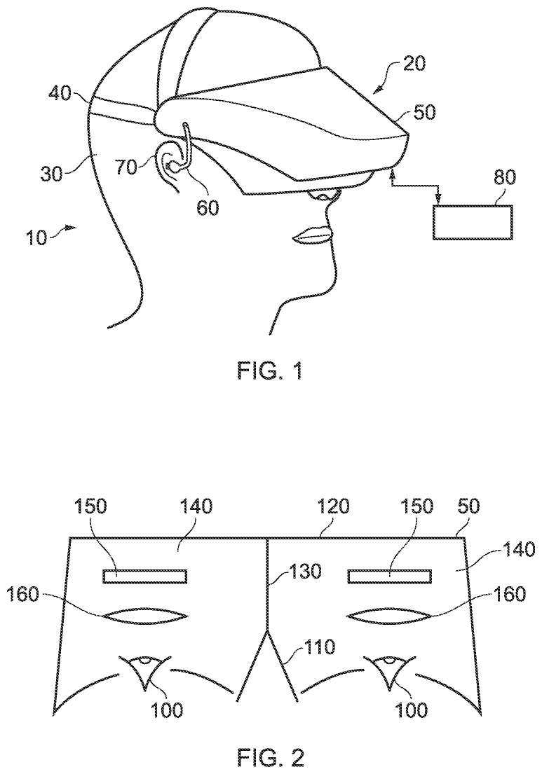

Referring now to the drawings, wherein like reference numerals designate identical or corresponding parts throughout the several views, in FIG. 1 a user 10 is wearing an HMD 20 (as an example of a generic head-mountable apparatus—other examples including audio headphones or a head-mountable light source) on the user's head 30. The HMD comprises a frame 40, in this example formed of a rear strap and a top strap, and a display portion 50. As noted above, many gaze tracking arrangements may be considered particularly suitable for use in HMD systems; however, use with such an HMD system should not be considered essential.

Note that the HMD of FIG. 1 may comprise further features, to be described below in connection with other drawings, but which are not shown in FIG. 1 for clarity of this initial explanation.

The HMD of FIG. 1 completely (or at least substantially completely) obscures the user's view of the surrounding environment. All that the user can see is the pair of images displayed within the HMD, as supplied by an external processing device such as a games console in many embodiments. Of course, in some embodiments images may instead (or additionally) be generated by a processor or obtained from memory located at the HMD itself.

The HMD has associated headphone audio transducers or earpieces 60 which fit into the user's left and right ears 70. The earpieces 60 replay an audio signal provided from an external source, which may be the same as the video signal source which provides the video signal for display to the user's eyes.

The combination of the fact that the user can see only what is displayed by the HMD and, subject to the limitations of the noise blocking or active cancellation properties of the earpieces and associated electronics, can hear only what is provided via the earpieces, mean that this HMD may be considered as a so-called “full immersion” HMD. Note however that in some embodiments the HMD is not a full immersion HMD, and may provide at least some facility for the user to see and/or hear the user's surroundings. This could be by providing some degree of transparency or partial transparency in the display arrangements, and/or by projecting a view of the outside (captured using a camera, for example a camera mounted on the HMD) via the HMD's displays, and/or by allowing the transmission of ambient sound past the earpieces and/or by providing a microphone to generate an input sound signal (for transmission to the earpieces) dependent upon the ambient sound.

A front-facing camera 122 may capture images to the front of the HMD, in use. Such images may be used for head tracking purposes, in some embodiments, while it may also be suitable for capturing images for an augmented reality (AR) style experience. A Bluetooth® antenna 124 may provide communication facilities or may simply be arranged as a directional antenna to allow a detection of the direction of a nearby Bluetooth® transmitter.

In operation, a video signal is provided for display by the HMD. This could be provided by an external video signal source 80 such as a video games machine or data processing apparatus (such as a personal computer), in which case the signals could be transmitted to the HMD by a wired or a wireless connection 82. Examples of suitable wireless connections include Bluetooth® connections. Audio signals for the earpieces 60 can be carried by the same connection. Similarly, any control signals passed from the HMD to the video (audio) signal source may be carried by the same connection. Furthermore, a power supply 83 (including one or more batteries and/or being connectable to a mains power outlet) may be linked by a cable 84 to the HMD. Note that the power supply 83 and the video signal source 80 may be separate units or may be embodied as the same physical unit. There may be separate cables for power and video (and indeed for audio) signal supply, or these may be combined for carriage on a single cable (for example, using separate conductors, as in a USB cable, or in a similar way to a “power over Ethernet” arrangement in which data is carried as a balanced signal and power as direct current, over the same collection of physical wires). The video and/or audio signal may be carried by, for example, an optical fibre cable. In other embodiments, at least part of the functionality associated with generating image and/or audio signals for presentation to the user may be carried out by circuitry and/or processing forming part of the HMD itself. A power supply may be provided as part of the HMD itself.

Some embodiments of the invention are applicable to an HMD having at least one electrical and/or optical cable linking the HMD to another device, such as a power supply and/or a video (and/or audio) signal source. So, embodiments of the invention can include, for example:

(a) an HMD having its own power supply (as part of the HMD arrangement) but a cabled connection to a video and/or audio signal source;

(b) an HMD having a cabled connection to a power supply and to a video and/or audio signal source, embodied as a single physical cable or more than one physical cable;

(c) an HMD having its own video and/or audio signal source (as part of the HMD arrangement) and a cabled connection to a power supply; or

(d) an HMD having a wireless connection to a video and/or audio signal source and a cabled connection to a power supply.

If one or more cables are used, the physical position at which the cable 82 and/or 84 enters or joins the HMD is not particularly important from a technical point of view. Aesthetically, and to avoid the cable(s) brushing the user's face in operation, it would normally be the case that the cable(s) would enter or join the HMD at the side or back of the HMD (relative to the orientation of the user's head when worn in normal operation). Accordingly, the position of the cables 82, 84 relative to the HMD in FIG. 1 should be treated merely as a schematic representation.

Accordingly, the arrangement of FIG. 1 provides an example of a head-mountable display system comprising a frame to be mounted onto an observer's head, the frame defining one or two eye display positions which, in use, are positioned in front of a respective eye of the observer and a display element mounted with respect to each of the eye display positions, the display element providing a virtual image of a video display of a video signal from a video signal source to that eye of the observer.

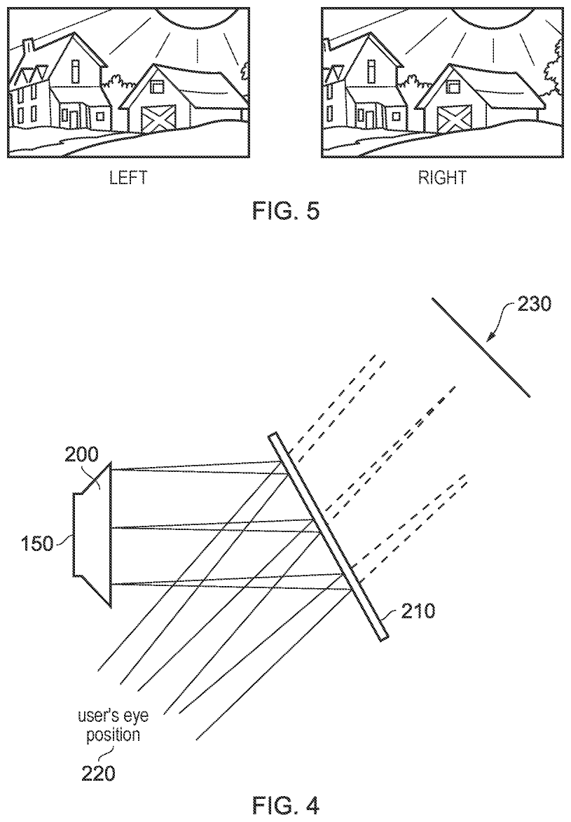

FIG. 1 shows just one example of an HMD. Other formats are possible: for example an HMD could use a frame more similar to that associated with conventional eyeglasses, namely a substantially horizontal leg extending back from the display portion to the top rear of the user's ear, possibly curling down behind the ear. In other (not full immersion) examples, the user's view of the external environment may not in fact be entirely obscured; the displayed images could be arranged so as to be superposed (from the user's point of view) over the external environment. An example of such an arrangement will be described below with reference to FIG. 4.

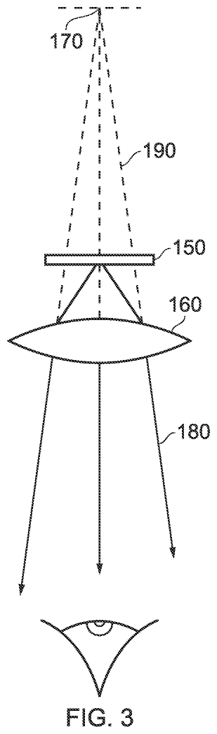

In the example of FIG. 1, a separate respective display is provided for each of the user's eyes. A schematic plan view of how this is achieved is provided as FIG. 2, which illustrates the positions 100 of the user's eyes and the relative position 110 of the user's nose. The display portion 50, in schematic form, comprises an exterior shield 120 to mask ambient light from the user's eyes and an internal shield 130 which prevents one eye from seeing the display intended for the other eye. The combination of the user's face, the exterior shield 120 and the interior shield 130 form two compartments 140, one for each eye. In each of the compartments there is provided a display element 150 and one or more optical elements 160. The way in which the display element and the optical element(s) cooperate to provide a display to the user will be described with reference to FIG. 3.

Referring to FIG. 3, the display element 150 generates a displayed image which is (in this example) refracted by the optical elements 160 (shown schematically as a convex lens but which could include compound lenses or other elements) so as to generate a virtual image 170 which appears to the user to be larger than and significantly further away than the real image generated by the display element 150. As an example, the virtual image may have an apparent image size (image diagonal) of more than 1 m and may be disposed at a distance of more than 1 m from the user's eye (or from the frame of the HMD). In general terms, depending on the purpose of the HMD, it is desirable to have the virtual image disposed a significant distance from the user. For example, if the HMD is for viewing movies or the like, it is desirable that the user's eyes are relaxed during such viewing, which requires a distance (to the virtual image) of at least several metres. In FIG. 3, solid lines (such as the line 180) are used to denote real optical rays, whereas broken lines (such as the line 190) are used to denote virtual rays.

An alternative arrangement is shown in FIG. 4. This arrangement may be used where it is desired that the user's view of the external environment is not entirely obscured. However, it is also applicable to HMDs in which the user's external view is wholly obscured. In the arrangement of FIG. 4, the display element 150 and optical elements 200 cooperate to provide an image which is projected onto a mirror 210, which deflects the image towards the user's eye position 220. The user perceives a virtual image to be located at a position 230 which is in front of the user and at a suitable distance from the user.

In the case of an HMD in which the user's view of the external surroundings is entirely obscured, the mirror 210 can be a substantially 100% reflective mirror. The arrangement of FIG. 4 then has the advantage that the display element and optical elements can be located closer to the centre of gravity of the user's head and to the side of the user's eyes, which can produce a less bulky HMD for the user to wear. Alternatively, if the HMD is designed not to completely obscure the user's view of the external environment, the mirror 210 can be made partially reflective so that the user sees the external environment, through the mirror 210, with the virtual image superposed over the real external environment.

In the case where separate respective displays are provided for each of the user's eyes, it is possible to display stereoscopic images. An example of a pair of stereoscopic images for display to the left and right eyes is shown in FIG. 5. The images exhibit a lateral displacement relative to one another, with the displacement of image features depending upon the (real or simulated) lateral separation of the cameras by which the images were captured, the angular convergence of the cameras and the (real or simulated) distance of each image feature from the camera position.

Note that the lateral displacements in FIG. 5 could in fact be the other way round, which is to say that the left eye image as drawn could in fact be the right eye image, and the right eye image as drawn could in fact be the left eye image. This is because some stereoscopic displays tend to shift objects to the right in the right eye image and to the left in the left eye image, so as to simulate the idea that the user is looking through a stereoscopic window onto the scene beyond. However, some HMDs use the arrangement shown in FIG. 5 because this gives the impression to the user that the user is viewing the scene through a pair of binoculars. The choice between these two arrangements is at the discretion of the system designer.

In some situations, an HMD may be used simply to view movies and the like. In this case, there is no change required to the apparent viewpoint of the displayed images as the user turns the user's head, for example from side to side. In other uses, however, such as those associated with virtual reality (VR) or augmented reality (AR) systems, the user's viewpoint needs to track movements with respect to a real or virtual space in which the user is located.

As mentioned above, in some uses of the HMD, such as those associated with virtual reality (VR) or augmented reality (AR) systems, the user's viewpoint needs to track movements with respect to a real or virtual space in which the user is located.

This tracking is carried out by detecting motion of the HMD and varying the apparent viewpoint of the displayed images so that the apparent viewpoint tracks the motion. The detection may be performed using any suitable arrangement (or a combination of such arrangements). Examples include the use of hardware motion detectors (such as accelerometers or gyroscopes), external cameras operable to image the HMD, and outwards-facing cameras mounted onto the HMD.

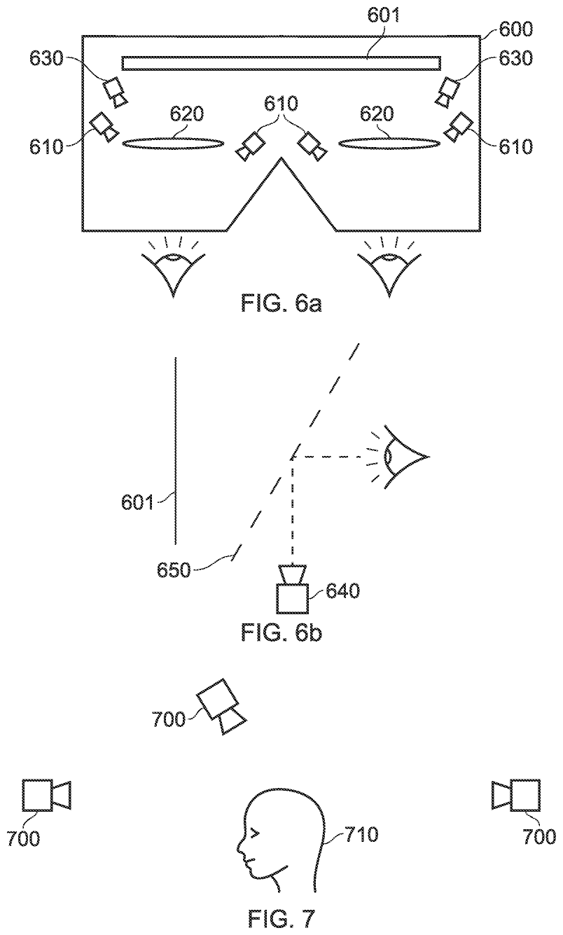

Turning to gaze tracking in such an arrangement, FIG. 6 schematically illustrates two possible arrangements for performing eye tracking on an HMD. The cameras provided within such arrangements may be selected freely so as to be able to perform an effective eye-tracking method. In some existing arrangements, visible light cameras are used to capture images of a user's eyes. Alternatively, infra-red (IR) cameras are used so as to reduce interference either in the captured signals or with the user's vision should a corresponding light source be provided, or to improve performance in low-light conditions.

FIG. 6a shows an example of a gaze tracking arrangement in which the cameras are arranged within an HMD so as to capture images of the user's eyes from a short distance. This may be referred to as near-eye tracking, or head-mounted tracking.

In this example, an HMD 600 (with a display element 601) is provided with cameras 610 that are each arranged so as to directly capture one or more images of a respective one of the user's eyes using an optical path that does not include the lens 620. This may be advantageous in that distortion in the captured image due to the optical effect of the lens is able to be avoided. Four cameras 610 are shown here as examples of possible positions that eye-tracking cameras may provided, although it should be considered that any number of cameras may be provided in any suitable location so as to be able to image the corresponding eye effectively. For example, only one camera may be provided per eye or more than two cameras may be provided for each eye.

However it is considered that in a number of embodiments it is advantageous that the cameras are instead arranged so as to include the lens 620 in the optical path used to capture images of the eye. Examples of such positions are shown by the cameras 630. While this may result in processing being required to enable suitably accurate tracking to be performed, due to the deformation in the captured image due to the lens, this may be performed relatively simply due to the fixed relative positions of the corresponding cameras and lenses. An advantage of including the lens within the optical path may be that of simplifying the physical constraints upon the design of an HMD, for example.

FIG. 6b shows an example of a gaze tracking arrangement in which the cameras are instead arranged so as to indirectly capture images of the user's eyes. Such an arrangement may be particularly suited to use with IR or otherwise non-visible light sources, as will be apparent from the below description.

FIG. 6b includes a mirror 650 arranged between a display 601 and the viewer's eye (of course, this can be extended to or duplicated at the user's other eye as appropriate). For the sake of clarity, any additional optics (such as lenses) are omitted in this Figure—it should be appreciated that they may be present at any suitable position within the depicted arrangement. The mirror 650 in such an arrangement is selected so as to be partially transmissive; that is, the mirror 650 should be selected so as to enable the camera 640 to obtain an image of the user's eye while the user views the display 601. One method of achieving this is to provide a mirror 650 that is reflective to IR wavelengths but transmissive to visible light—this enables IR light used for tracking to be reflected from the user's eye towards the camera 640 while the light emitted by the display 601 passes through the mirror uninterrupted.

Such an arrangement may be advantageous in that the cameras may be more easily arranged out of view of the user, for instance. Further to this, improvements to the accuracy of the eye tracking may be obtained due to the fact that the camera captures images from a position that is effectively (due to the reflection) along the axis between the user's eye and the display.

Of course, eye-tracking arrangements need not be implemented in a head-mounted or otherwise near-eye fashion as has been described above. For example, FIG. 7 schematically illustrates a system in which a camera is arranged to capture images of the user from a distance; this distance may vary during tracking, and may take any value in dependence upon the parameters of the tracking system. For example, this distance may be thirty centimetres, a metre, five metres, ten metres, or indeed any value so long as the tracking is not performed using an arrangement that is affixed to the user's head.

In FIG. 7, an array of cameras 700 is provided that together provide multiple views of the user 710. These cameras are configured to capture information identifying at least the direction in which a user's 710 eyes are focused, using any suitable method. For example, IR cameras may be utilised to identify reflections from the user's 710 eyes. An array of cameras 700 may be provided so as to provide multiple views of the user's 710 eyes at any given time, or may be provided so as to simply ensure that at any given time at least one camera 700 is able to view the user's 710 eyes. It is apparent that in some use cases it may not be necessary to provide such a high level of coverage and instead only one or two cameras 700 may be used to cover a smaller range of possible viewing directions of the user 710.

Of course, the technical difficulties associated with such a long-distance tracking method may be increased; higher resolution cameras may be required, as may stronger light sources for generating IR light, and further information (such as head orientation of the user) may need to be input to determine a focus of the user's gaze. The specifics of the arrangement may be determined in dependence upon a required level of robustness, accuracy, size, and/or cost, for example, or any other design consideration.

Despite technical challenges including those discussed above, such tracking methods may be considered beneficial in that they allow a greater range of interactions for a user—rather than being limited to HMD viewing, gaze tracking may be performed for a viewer of a television, for instance.

Rather than varying only in the location in which cameras are provided, eye-tracking arrangements may also differ in where the processing of the captured image data to determine tracking data is performed.

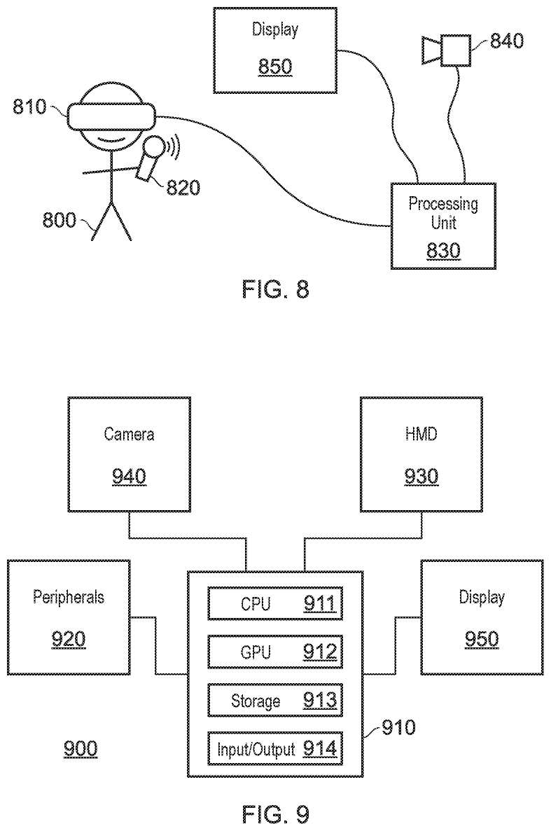

FIG. 8 schematically illustrates an environment in which an eye-tracking process may be performed. In this example, the user 800 is using an HMD 810 that is associated with the processing unit 830, such as a games console, with the peripheral 820 allowing a user 800 to input commands to control the processing. The HMD 810 may perform eye tracking in line with an arrangement exemplified by FIG. 6a or 6b, for example—that is, the HMD 810 may comprise one or more cameras operable to capture images of either or both of the user's 800 eyes. The processing unit 830 may be operable to generate content for display at the HMD 810; although some (or all) of the content generation may be performed by processing units within the HMD 810.

The arrangement in FIG. 8 also comprises a camera 840, located outside of the HMD 810, and a display 850. In some cases, the camera 840 may be used for performing tracking of the user 800 while using the HMD 810, for example to identify body motion or a head orientation. The camera 840 and display 850 may be provided as well as or instead of the HMD 810; for example these may be used to capture images of a second user and to display images to that user while the first user 800 uses the HMD 810, or the first user 800 may be tracked and view content with these elements instead of the HMD 810. That is to say, the display 850 may be operable to display generated content provided by the processing unit 830 and the camera 840 may be operable to capture images of one or more users' eyes to enable eye-tracking to be performed.

While the connections shown in FIG. 8 are shown by lines, this should of course not be taken to mean that the connections should be wired; any suitable connection method, including wireless connections such as wireless networks or Bluetooth®, may be considered suitable. Similarly, while a dedicated processing unit 830 is shown in FIG. 8 it is also considered that the processing may in some embodiments be performed in a distributed manner—such as using a combination of two or more of the HMD 810, one or more processing units, remote servers (cloud processing), or games consoles.

The processing required to generate tracking information from captured images of the user's 800 eye or eyes may be performed locally by the HMD 810, or the captured images or results of one or more detections may be transmitted to an external device (such as a the processing unit 830) for processing. In the former case, the HMD 810 may output the results of the processing to an external device for use in an image generation process if such processing is not performed exclusively at the HMD 810. In embodiments in which the HMD 810 is not present, captured images from the camera 840 are output to the processing unit 830 for processing.

FIG. 9 schematically illustrates a system for performing one or more eye tracking processes, for example in an embodiment such as that discussed above with reference to FIG. 8. The system 900 comprises a processing device 910, one or more peripherals 920, an HMD 930, a camera 940, and a display 950. Of course, not all elements need be present within the system 900 in a number of embodiments—for instance, if the HMD 930 is present then it is considered that the camera 940 may be omitted as it is unlikely to be able to capture images of the user's eyes.

As shown in FIG. 9, the processing device 910 may comprise one or more of a central processing unit (CPU) 911, a graphics processing unit (GPU) 912, storage (such as a hard drive, or any other suitable data storage medium) 913, and an input/output 914. These units may be provided in the form of a personal computer, a games console, or any other suitable processing device.

For example, the CPU 911 may be configured to generate tracking data from one or more input images of the user's eyes from one or more cameras, or from data that is indicative of a user's eye direction. This may be data that is obtained from processing images of the user's eye at a remote device, for example. Of course, should the tracking data be generated elsewhere then such processing would not be necessary at the processing device 910.

The GPU 912 may be configured to generate content for display to the user on which the eye tracking is being performed. In some embodiments, the content itself may be modified in dependence upon the tracking data that is obtained—an example of this is the generation of content in accordance with a foveal rendering technique. Of course, such content generation processes may be performed elsewhere—for example, an HMD 930 may have an on-board GPU that is operable to generate content in dependence upon the eye tracking data.

The storage 913 may be provided so as to store any suitable information. Examples of such information include program data, content generation data, and eye tracking model data. In some cases, such information may be stored remotely such as on a server, and as such a local storage 913 may not be required—the discussion of the storage 913 should therefore be considered to refer to local (and in some cases removable storage media) or remote storage.

The input/output 914 may be configured to perform any suitable communication as appropriate for the processing device 910. Examples of such communication include the transmission of content to the HMD 930 and/or display 950, the reception of eye-tracking data and/or images from the HMD 930 and/or the camera 940, and communication with one or more remote servers (for example, via the internet).

As discussed above, the peripherals 920 may be provided to allow a user to provide inputs to the processing device 910 in order to control processing or otherwise interact with generated content. This may be in the form of button presses or the like, or alternatively via tracked motion to enable gestures to be used as inputs.

The HMD 930 may comprise a number of sub-elements, which have been omitted from

FIG. 9 for the sake of clarity. Of course, the HMD 930 should comprise a display unit operable to display images to a user. In addition to this, the HMD 930 may comprise any number of suitable cameras for eye tracking (as discussed above), in addition to one or more processing units that are operable to generate content for display and/or generate eye tracking data from the captured images.

The camera 940 and display 950 may be configured in accordance with the discussion of the corresponding elements above with respect to FIG. 8.

Turning to the image capture process upon which the eye tracking is based, examples of different cameras are discussed. The first of these is a standard camera, which captures a sequence of images of the eye that may be processed to determine tracking information. The second is that of an event camera, which instead generates outputs in response to observed changes in the incident light, as discussed later.

Traditional image-based gaze tracking techniques use standard cameras given that they are widely available and often relatively cheap to produce. ‘Standard cameras’ here refer to cameras which capture images of the environment at predetermined intervals which can be combined to generate video content. For example, a typical camera of this type may capture thirty image frames each second, and these images may be output to a processing unit for feature analysis or the like to be performed so as to enable tracking of the eye.

Such a camera comprises a light-sensitive array that is operable to record light information during an exposure time, with the exposure time being controlled by a shutter speed (the speed of which dictates the frequency of image capture). The shutter may be configured as a rolling shutter (line-by-line reading of the captured information) or a global shutter (reading the captured information of the whole frame simultaneously), for example.

Independent of the type of camera that is selected, in many cases it may be advantageous to provide illumination to the eye in order to obtain a suitable image. One example of this is the provision of an IR light source that is configured to emit light in the direction of one or both of the user's eyes; an IR camera may then be provided that is able to detect reflections from the user's eye in order to generate an image. IR light may be preferable as it is invisible to the human eye, and as such does not interfere with normal viewing of content by the user, but it is not considered to be essential. In some cases, the illumination may be provided by a light source that is affixed to the imaging device, while in other embodiments it may instead be that the light source is arranged away from the imaging device.

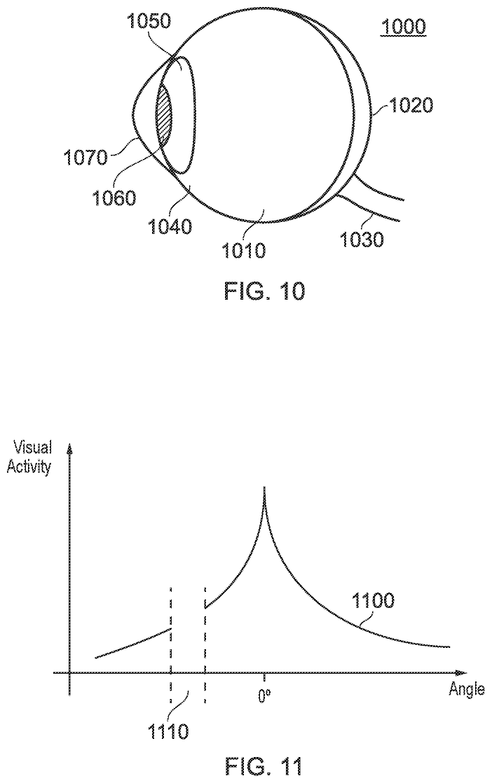

As suggested in the discussion above, the human eye does not have a uniform structure; that is, the eye is not a perfect sphere, and different parts of the eye have different characteristics (such as varying reflectance or colour). FIG. 10 shows a simplified side view of the structure of a typical eye 1000; this Figure has omitted features such as the muscles which control eye motion for the sake of clarity.

The eye 1000 is formed of a near-spherical structure filled with an aqueous solution 1010, with a retina 1020 formed on the rear surface of the eye 1000. The optic nerve 1030 is connected at the rear of the eye 1000. Images are formed on the retina 1020 by light entering the eye 1000, and corresponding signals carrying visual information are transmitted from the retina 1020 to the brain via the optic nerve 1030.

Turning to the front surface of the eye 1000, the sclera 1040 (commonly referred to as the white of the eye) surrounds the iris 1050. The iris 1050 controls the size of the pupil 1060, which is an aperture through which light enters the eye 1000. The iris 1050 and pupil 1060 are covered by the cornea 1070, which is a transparent layer which can refract light entering the eye 1000. The eye 1000 also comprises a lens (not shown) that is present behind the iris 1050 that may be controlled to adjust the focus of the light entering the eye 1000.

The structure of the eye is such that there is an area of high visual acuity (the fovea), with a sharp drop off either side of this. This is illustrated by the curve 1100 of FIG. 11, with the peak in the centre representing the foveal region. The area 1110 is the ‘blind spot’; this is an area in which the eye has no visual acuity as it corresponds to the area where the optic nerve meets the retina. The periphery (that is, the viewing angles furthest from the fovea) is not particularly sensitive colour or detail, and instead is used to detect motion.

As has been discussed above, foveal rendering is a rendering technique that takes advantage of the relatively small size (around 2.5 degrees) of the fovea and the sharp fall-off in acuity outside of that.

The eye undergoes a large amount of motion during viewing, and this motion may be categorised into one of a number of categories.

A saccadic eye movement is identified as a fast motion of the eye in which the eye moves in a ballistic manner to abruptly change a point of fixation. This may be considered as ballistic movement, in that once the movement of the eye has been initiated to change a point of focus from a current point of focus to a target point of focus (next point of focus), the target point of focus and the direction of movement of the eye to move the point of focus to the target point of focus cannot be altered by the human visual system. As such, during the course of the eye movement to change the saccade from the current fixation point to the next fixation point for the eye it is not possible to interrupt the eye movement, and upon reaching the target fixation point the eye remains stationary for a period of time (a fixation pause) to focus on the target fixation point before subsequent eye movement can be initiated. It is sometimes observed that a saccade is followed by a second smaller corrective saccade that is performed to bring the eye closer to the target fixation point. Such a corrective saccade typically occurs after a very short period of time. A saccade can range in size from a small eye movement made while reading, for example, to a much larger eye movement made when observing a surrounding environment. Saccades are often not conscious eye movements, and instead are performed reflexively to focus on a target when surveying an environment. Saccades may last up to two hundred milliseconds, depending on the angle rotated by the eye to change the position of the fovea and thus the foveal region of the viewer's vision to thereby change the point of fixation for the eye, but may be as short as twenty milliseconds. The rotational speed of the eye during a saccade is also dependent upon a magnitude of a total rotation angle of the eye; typical speeds may range from two hundred to five hundred degrees per second.

‘Smooth pursuit’ refers to a slower movement type than a saccade. Smooth pursuit is generally associated with a conscious tracking of a point of focus by a viewer, and is performed so as to maintain the position of a target within (or at least substantially within) the foveal region of the viewer's vision. This enables a high-quality view of a target of interest to be maintained in spite of motion. If the target moves too fast, then smooth pursuit may instead require a number of saccades in order to keep up; this is because smooth pursuit has a lower maximum speed, in the region of thirty degrees per second.

The vestibular-ocular reflex is a further example of eye motion. The vestibular-ocular reflex is the motion of the eyes that counteracts head motion; that is, the motion of the eyes relative to the head that enables a person to remain focused on a particular point despite moving their head.

Another type of motion is that of the vergence accommodation reflex. This is the motion that causes the eyes to rotate to converge at a point, and the corresponding adjustment of the lens within the eye to cause that point to come into focus.

Further eye motions that may be observed as a part of a gaze tracking process are those of blinks or winks, in which the eyelid covers the eyes of the user.

Movements of the eye are performed by a user wearing an HMD whilst viewing images displayed by the HMD to enable detailed visual analysis of a portion of an image displayed by the HMD. In particular, the eye can be rotated to reposition the fovea and the pupil to enable detailed visual analysis for the portion of the image for which light is incident upon the fovea. Similarly, movements of the eye are also performed by a user not wearing an HMD whilst viewing images displayed by a display unit, such as the display unit 850 or 950 described previously with reference to FIGS. 8 and 9.

Conventional techniques for foveated rendering typically require multiple render passes to allow an image frame to be rendered multiple times at different image resolutions so that the resulting renders are then composited together to achieve regions of different image resolution in an image frame. The use of multiple render passes requires significant processing overhead and undesirable image artefacts can arise at the boundaries between the regions. Alternatively, in some cases hardware can be used that allows rendering at different resolutions in different parts of an image frame without needing additional render passes. Such hardware-accelerated implementations may therefore be better in terms of performance, but this comes with limitations as to the smoothness of the transition between the regions of different image resolution within the image frame. In some implementations, only a limited number of regions can be used and a noticeably sharp drop in image resolution is observed between the regions.

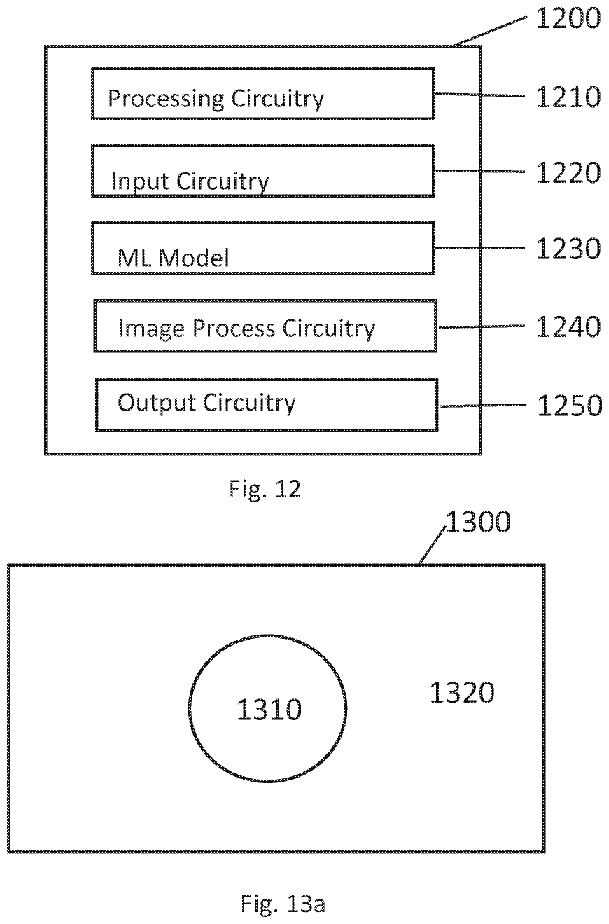

Turning now to FIG. 12, embodiments of the present description relate to using machine learning (ML) to predict a location in an image frame corresponding to where a user may be expected to look, the location then being used as the locus for performing foveated rendering, and/or equivalently lossy compression or other data reduction techniques favouring retention of image data around that locus.

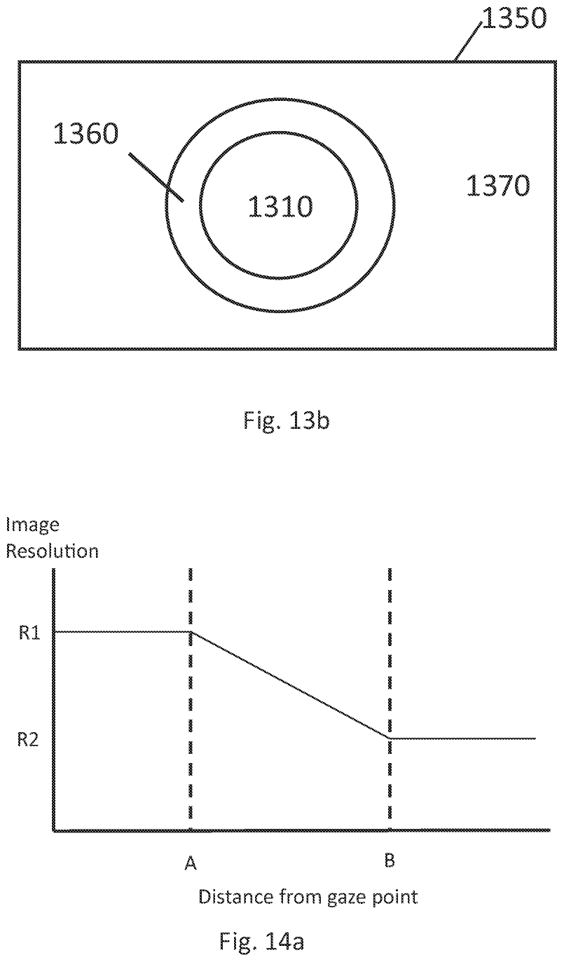

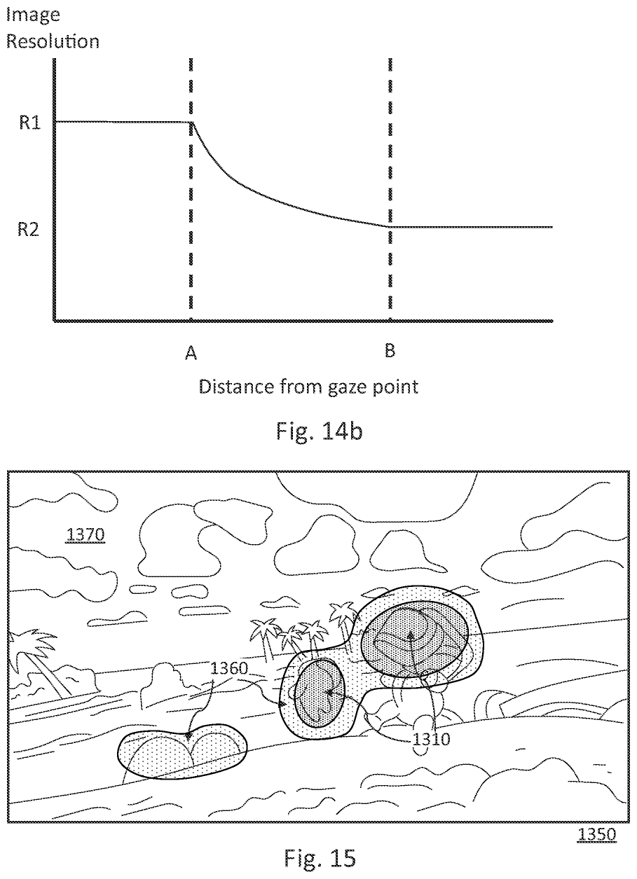

Turning now also to FIGS. 13 and 14, in this way, a first quality of an image 1300 is provided in a first region 1310 corresponding to where the user is predicted to gaze, whilst a second quality of the image is provided in a second region 1320 not predicted to be where the user will gaze. The first quality is higher than the second quality by virtue of foveated rendering and/or differentiated compression or other selective data increase or decrease within the image, as described herein.

The transition from first quality to second quality within the image may be instantaneous at the first region boundary, as shown in FIG. 13a, or may ramp between the first and second qualities in a linear or non-linear manner over a predetermined distance from the first region, as shown in FIG. 13b and FIGS. 14a and 14b. In FIG. 13B, an image 1350 comprises the first region 1310 and a modified second region 1370, with a transition region 1360 between them. The ramp in quality between the first and second regions through the transition region is then illustrated fora linear change (in this case, of image resolution for foveated rendering, but equally for data retention during compression) in FIG. 14a, and a nonlinear change in FIG. 14b. In each of FIGS. 14A and 14B, the dotted lines a B represent the effect of boundaries between the first and second regions 1310 and 1370, whilst R1 and R2 are indicative of the relative quality in the first and second regions (here specifically as image resolution, but this is a non-limiting example).

Returning to FIG. 12, this schematically illustrates a data processing system 1200 for predicting gaze positons.

In embodiments of the disclosure, the data processing system 1200 comprises processing circuitry 1210, configured to receive image data and process it for input to an ML model. This processing may take any suitable form, including reducing the image to greyscale, and/or reducing the colour depth for example to 16 or 8 bits; reducing the resolution of the image, for example from 1920×1080 to 480×270, or any other suitable resolution, including resolutions that do not preserve the aspect ratio of the source image; this processing helps to regularise the input for the ML system for example to a consistent colour or greyscale scheme and consistent resolution.

In any case, the optionally pre-processed image may then be presented as input to the machine learning system, either as image data and/or after further processing has been performed, such as a 2D Fourier transform of the image (which may be truncated to characterise large, low frequency components of a scene); generating deltas (differences) between one or more successive images (or Fourier transforms) of a video sequence, either before or after any changes in colour or resolution have been applied; or using associated data included as part of an existing encoded video, such as motion vectors.

Hence one or more of the original image, a colour regularised image, a resolution regularised image, at least part of a Fourier transform of one at least of these images; deltas of at least one of these images or transforms, and at least some motion vectors associated with the image may be used as input to the ML system. These inputs characterise what features of a scene are present within the image. In addition sound (such as stereo sound or 5.1 or 7.1 sound) may also be input, again after any suitable volume normalisation, and any suitable processing; for example the sound may be converted into a Mel-Cepstrum for each channel. Such sounds can provide additional correlation for example between people speaking within the images, or the occurrence of an explosion within the images.

In embodiments of the disclosure, the data processing system 1200 also comprises input circuitry 1220 to receive data indicative of a gaze point of an eye of a user for the image frame, using any of the techniques discussed elsewhere herein. This is indicative of where within the image the user is gazing (and hence also at what feature(s) within the image). The gaze point may be a pair of coordinates, or a flag or confidence value assigned to a coordinate position or a tile on a grid, or a region of preferred size/shape/area centred upon such coordinates or tile position; the coordinate system or grid typically having a resolution consistent with the effective resolution of the input(s) from the image, so that the correlation is more clearly retained.

In embodiments of the disclosure, the data processing system 1200 also comprises a machine learning model 1230. The machine learning model can be any suitable learning system, such as a neural network. The ML model learns to associate features of the input image(s) with the direction of gaze of the user and thus, once adequately trained, can predict the direction of gaze of a user given new, similarly processed, input image(s).

To provide a training set for the ML system, test users watch representative content whilst having their gaze tracked. This may be done using an HMD as described elsewhere herein; if the content is VR content then both gaze and optionally head tracking may be used. If the content is traditional 2D or 3D fixed viewpoint content (such as a film or TV show) then the content may be displayed on a virtual screen at a typical viewing distance from the user. Equivalently the gaze tracking may be performed whilst the user is watching a real screen.

In either case, the resulting training set provides corresponding gaze data for a set of images within the representative content (which may comprise multiple individual content items).

Where multiple users view the same content, the gaze data may take the form of multiple gaze points, or a mean gaze point, or gaze confidence values at such points, or a 2D histogram of gaze points or gaze confidence values, or a heatmap of gaze points or gaze confidence values. The form of the gaze data may be selected according to how many test users view the same content.

The ML system is then trained using the image data (optionally pre-processed according to one or more of the techniques disclosed herein) as input, and the gaze data, optionally preprocessed for use by the machine learning system, as output (target data) to learn to predict the gaze position. The output may hence be a prediction of one or more gaze points, an average gaze point, a confidence value at such a point or points, or a histogram or heatmap of gazepoint probability, depending on the nature of the target data. The data processing system 1200 comprises output circuitry 1242 output result of the machine learning system, and optionally implement post-processing to parse the result of a machine learning system, for example to convert it into first region 1310, second region 1320, 1370, and optionally transition region 1360 in a form that is suitable to the original image upon which subsequent image processing is to be performed.

It will be appreciated that different genres of content may be watched differently, or have characteristic watching behaviours; hence for example uses viewing a news cast are likely to concentrate on the presenters face, whereas when watching an action movie they may concentrate on areas of fast movement, and meanwhile for a football match they may concentrate on the ball.

Hence optionally different respective machine learning systems may be trained for different genres of content, or in principle for specific titles (whether these are individual instances of content, or one or more seasons thereof).

Similarly it will be appreciated that different demographics of viewer may watch the same content differently, concentrating on different aspects of the images. Hence optionally different respective machine learning systems may be trained based on gaze data from respective demographics of viewer; it will be appreciated that this may also be combined with training for specific genres or titles.

In any event, the predicted point or region of gaze output by the machine learning system is then used in place of a live gaze position that may be tracked for a user.

Notably therefore (predicted) gaze dependent image processing can then be performed in advance of consumption of the content by the end-user.

The data processing system 1200 comprises image processing circuitry 1240 configured to perform this gaze dependent image processing. The processing may comprise foveated rendering to preferentially boost the resolution or other aspect of image quality in the first region 1310 coincident with the predicted point or region of gaze, and/or a differentiated image compression or decimation technique used to limit the data size of the respective image during transmission to a predetermined budget, with the compression and or decimation being greater within the second area (1320, 1370) than in the first area 1310. Where a transition area 1360 is provided, then in the case of foveated rendering either a stepwise intermediate resolution boost can be provided that is less than in the first region but still more than is found in the second, or a ramp can be provided for example by rendering additional pixels within the transition region as a function of probability or percentage determined by the linear or non-linear ramp between the resolution of the first and second regions. More generally therefore, the image processing circuitry may perform one or more additive quality improvements and/or one or more subtractive quality reductions to respective regions of the image.

Hence advantageously pre-recorded content can be processed to have a differentiated image quality within each image, with comparatively high quality within the first region and lower quality within the second region, with an optional transition region between the two.

In this way, a substitute for live gaze tracking can be provided for pre-recorded material which otherwise cannot be modified in this way in response to live gaze tracking of the end-user (e.g. because of lag between the tracked case and communication of this information back to a server supplying content to the user, and also the considerable computational overhead of respectively modifying the images in response to the gaze of each individual user consuming the content).

It will be appreciated that the first region and the transition region do not need to be regular in shape (e.g. circular, oval, or square), or singular or contiguous. Referring now to FIG. 15, this illustrates a scene from some content. Historically users whose gaze data has been provided for training purposes have predominantly looked at the heads of the two main characters, and occasionally at additional or newly arriving characters in similar scenes.

Hence in an optional embodiment of the present description, the machine learning system predicts a high probability of gaze (for example above a first threshold probability) in two positions corresponding to region 1310, and a lower probability (for example above a second, lower threshold probability) in regions 1360. The remainder of the image 1370 does not have a sufficiently high probability to meet either threshold.

In this case, the first high-quality region 1310 can thus correspond to those parts of the image predicting a high probability of gaze above the first threshold probability, whether or not they are regular in shape or contiguous. Meanwhile optionally a transitional region 1360 can be defined by those parts of the image with a probability of gaze above the second threshold probability. Notably, optionally regions of the image may satisfy the second threshold without being adjacent to a region that satisfies the first threshold, as in the leftmost region 1360 in image 1350 of FIG. 15. In this case an intermediate quality lower than the quality in the first high-quality region can be used for such a region similar to the intermediate quality that can be used for a stepwise implementation of the transition region 1360.

It will be appreciated that where the predicted gaze occupies a small region or point, optionally the high-quality first region may be chosen to occupy a minimum area responsive to the prediction that may be larger than the area predicted by the machine learning system itself.

Similarly, it will be appreciated that where an image is being compressed to meet a fixed data budget, the size of the first region, as defined by the first threshold probability, and if used optionally the transition region as defined by the second threshold probability, can be altered in size until the data budget is met; hence for example one or both thresholds can be lowered to increase the amount of data required for the image (i.e. by increasing the corresponding size of the first region and optionally the transitional region, and hence also decreasing the size of the second region of the image, which is subject to more aggressive compression or decimation).

Alternatively or in addition, it will be appreciated that where an image is being compressed to meet a fixed data budget, the amount of compression in each of the respective regions (first 1310, transitional 1360—if used—and second 1370) can be increased; hence whilst the absolute quality of the first region may be reduced, it is still higher than that of the transitional and second regions. It will also be appreciated that the degree of increase can vary between the regions, for example with a greater increase within the second region than in the transitional region, and in turn a greater increase with the transitional region than the first region.

The above two approaches can interact for example if, in order to meet a data budget the area of the first region would become smaller than a preferred minimum size; consequently at this point the compression rates for one or more of the first, transitional—if used—and second regions can be increased.

In this way, based upon the machine learning gaze predictions, one or more regions of image can identified as a high-quality first region 1310, whilst remaining regions of the image represent a lower quality second region (1320, 1370), optionally separated by a transitional region 1360. Optionally the high-quality first region and further optionally the transitional region can be defined by threshold probabilities of gaze output by the machine learning system. Hence for example two thresholds can provide a three tier system with high-quality first region medium quality transition region and low quality second region portions of the image. It will be appreciated that the use of further such thresholds can result in more tiers and a finer graduation of quality, if considered appropriate. Such regions can be made subject to a minimum preferred size, for example corresponding to a size of region that may be expected to be subtended by the fovea of a user's eye. Such regions may be subject to differentiated quality, caused either by additive quality improvements such as in foveated rendering, or by subtractive quality reduction as in lossy compression or decimation. The degree of addition or subtraction may be subject to an overall data budget for the image, which may affect the extent of a given region within the image, or the degree of additional compression applied to it.

The data processing system 1200 also comprises output circuitry 1250 configured to output the image processed image(s), for example either to a storage (not shown) for later distribution, or to a distribution system (not shown) such as a broadcasting or streaming distribution system.

As noted previously herein, one use of this approach is to provide the equivalent of foveated rendering, and/or fovea responsive compression, for broadcast material (whether live or pre-recorded) where it is not possible to use the end users gaze information either because it is not collected, or because there is too much lag, or because there are too many users.

In this scheme, the user receives the broadcast material with at least a first region of the image that is predicted to be where the user will gaze being a first higher-quality, and at least a second region of the image that is not predicted to be where the user will gaze being at a second lower quality. As noted above there may also be one or more transitional areas between these two. Such a scheme may for example allow a film or TV programme to be selectively upscaled to 8K in predicted gaze regions, whilst remaining at 4K or conventional HD in other areas, or conversely for an 8K source to be selectively decimated or downscaled in regions outside the predicted gaze regions.

The examples of 8K, 4K, and conventional HD above are illustrative only and non-limiting.

In addition to such upscaling and/or compression, the above approach may be used where ever the position of a user's gaze upon content needs to be predicted before the content is presented to the user. One such example occurs in videogames, where, separate to foveated rendering itself which occurs during rasterisation of the image immediately prior to display to the user, it is also preferable to select level of detail (LoD) information for regions of a scene, which in turn determine the quality of geometry and optionally texture that is retrieved from memory for the purposes of generating and subsequently rendering the scene; typically the level of detail is chosen as a function of the user's direction movement within the game and the current draw distance of elements of the scene from the virtual camera representing the user's view. In the present embodiment, alternatively or in addition the level of detail is a function of where the user may be predicted to look within the scene; a predicted first region where the user is expected to gaze may thus be assigned an increased level of detail, enabling better geometry and optionally textures to be accessed a number of frames prior to their use in rendered images, which themselves may separately also optionally use foveated rendering.

Subsequently in use the end users gaze may optionally be tracked when viewing the image as presented to them, whether from any broadcast content or a locally run videogame in which one or more regions of the image have been subjected to the techniques described herein.

If the end user's gaze is tracked, then this tracking data can optionally be supplied, typically in association with identifiers for the image frames being viewed, back to the machine learning model (or a new model), potentially in conjunction with similar gaze tracking data from a plurality of other end-users, to refine an existing machine learning model, or train a new one. In this way the gaze prediction models for t a he genre or title of content can be improved. This approach may be particularly useful for streaming services where, instead of almost everybody watching the content live, only a small proportion of viewers watch the content immediately upon release, but these early viewers can provide training material to improve the experience for subsequent viewers.

It will also be appreciated that if an end user's gaze is tracked it can be determined whether or not they are looking at the first region of the image, the second region of the image or the transitional region. It would be preferable that they look at the first region, as this would provide the best experience for them. However if they are looking outside the first region or transitional region fora predetermined period of time (for example N frames where N a number greater than one, such as for example 4, 5, 8, 10, 24, 25, 30, 50, or 60), then remedial action can be taken. For example, a broadcast/streaming service can provide a high-quality high bandwidth image (for example equivalent to the image viewed by users during the generation of the test set), for example by switching to a new source, or by providing access to an image enhancement layer, so that the quality in the region user is looking at is increased; once the user's gaze moves back within the first or transitional regions, the broadcast/streaming service can switch back to the version of the image with differential quality based on predicted gaze.

Where a machine learning system has been trained for a number of different demographics of user, then the user may receive a stream corresponding to their demographic (if disclosed for example via a registration scheme). However, if the user's gaze is tracked then this can also be compared to the gaze positions predicted according to machine learning system is trained on other demographics, and if it appears that the user's gaze behaviour better fits one of the other sequence of gaze predictions, then the mitigation may comprise switching to a stream corresponding to a different demographic to that which the user may notionally belong to.

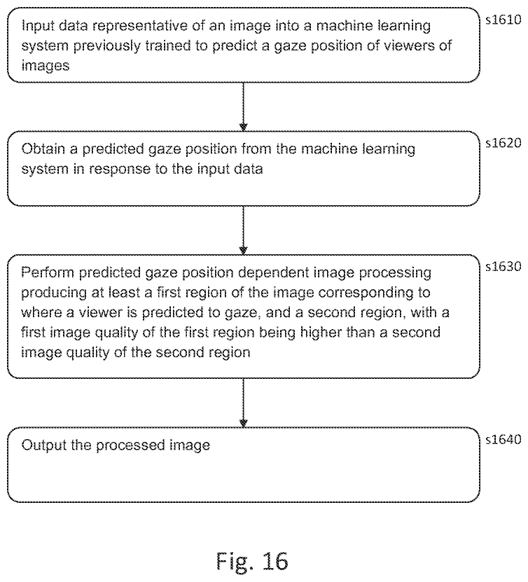

Turning now to FIG. 16, in a summary embodiment of the description, a method of image processing comprises the following steps.

In a first step s1610, input data representative of an image into a machine learning system previously trained to predict a gaze position of viewers of images, as described elsewhere herein.

In a second step s1620, obtain a predicted gaze position from the machine learning system in response to the input data, as described elsewhere herein.

In a third step s1630, perform predicted gaze position dependent image processing producing at least a first region of the image corresponding to where a viewer is predicted to gaze, and a second region (e.g. outside the or each first region and optionally also outside the or each transition region, if used), with a first image quality of the first region being higher than a second image quality of the second region, as described elsewhere herein.

Finally in a fourth step s1640, output the processed image (e.g. to storage, broadcast, stream, display, encoding or the like).

It will be apparent to a person skilled in the art that variations in the above method corresponding to operation of the various embodiments of the method and/or apparatus as described and claimed herein are considered within the scope of the present disclosure, including but not limited to that:
the image processing produces a transition region (1360), with an image quality between the first image quality and the second image quality, as described elsewhere herein;
the image processing performs additive quality improvement and/or subtractive quality reduction to respective regions of the image, as described elsewhere herein;
   in this case, the image processing performs one or more selected from the list consisting of foveated rendering in at least parts of the first region, image post-processing in at least parts of the first region, differentiated compression, with greater compression in at least parts of the second region than the first region, and decimation in at least parts of the second region, as described elsewhere herein;
the first region is defined responsive to a probability of viewer gaze at locations within the image, output by the machine learning system, exceeding a predetermined first threshold, as described elsewhere herein;
   in this case, the image processing generates an image according to a data size budget for the image, and the first threshold is adjusted responsive to the data size budget for the image, as described elsewhere herein;
   similarly in this case, at least a first transition region is defined responsive to a probability of viewer gaze at locations within the image, output by the machine learning system, exceeding a predetermined respective threshold lower than the predetermined first threshold, and wherein if a plurality of transition regions are defined using a hierarchy of thresholds, the resulting hierarchy of different transition regions have an associated hierarchy of image qualities, with higher thresholds corresponding to higher qualities, as described elsewhere herein;
the image processing produces one or more selected from the list consisting of a plurality of first regions, and a plurality of transitional regions, as described elsewhere herein;
the machine learning system is selected from amongst a plurality of machine learning systems each trained using one or more selected from the list consisting of data representative of images from a respective type of content as inputs, and data representative of gaze positions for a respective viewer demographic as targets, as described elsewhere herein;
the data representative of an image comprises one or more selected from the list consisting of a colour normalised image, a resolution normalised image, at least part of a Fourier transform of at least part of the image or a derivative image thereof, difference data for at least part of the image or a derivative image thereof and a proceeding corresponding image, at least some motion vectors associated with the image, and data representative of sound occurring within a predefined window centred on the occurrence of the image within a sequence of images having associated sound, as described elsewhere herein;
the method comprises tracking the gaze of a viewer of the output processed image, and supplying gaze data representative of the gaze of the viewer back to the machine learning model in conjunction with the corresponding input image to refine the training of the model, as described elsewhere herein;
the method comprises tracking the gaze of a viewer of the output processed image, and if the gaze of the viewer is directed to the second region of the output processed image for a predetermined period of time, then processing is performed to improve the effective quality of the second region for one or more subsequent images (for example by switching to the original image, providing a supplementary data layer, or switching to a different demographic model that better matches the user's gaze behaviour) , as described elsewhere herein;
the image (1300, 1350) is part of a pre-recorded or live video being streamed or broadcast, as described elsewhere herein; and
the image is part of a videogame, and wherein the predicted gaze position dependent image processing comprises selecting a level of detail for the first region, and accessing corresponding geometry data for the selected level of detail prior to rendering of a subsequent image, as described elsewhere herein.

It will be appreciated that the above methods may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, in a summary embodiment of the description, an image processing apparatus (1200) (for example a server, PC, or videogame console) comprises a machine learning system (1230) (for example run on a CPU of a server, PC, or videogame console) configured (for example by suitable software instruction) to obtain a predicted gaze position in response to the input data, the machine learning system having been previously trained to predict the gaze position of viewers of images, as described elsewhere herein.

The apparatus (1200) also comprises processing circuitry (1210) (again for example a CPU of a server, PC, or videogame console) configured (again for example by suitable software instruction) to input data representative of an image (1300, 1350) into the machine learning system 1230, as described elsewhere herein.

The apparatus (1200) further comprises image processing circuitry (1240) (again for example a CPU of a server, PC, or videogame console) configured (again for example by suitable software instruction) to perform predicted gaze position dependent image processing, the image processing producing at least a first region (1310) of the image corresponding to where a viewer is predicted to gaze, and a second region (1320, 1370), with a first image quality of the first region being higher than a second image quality of the second region, as described elsewhere herein.

Finally, the apparatus (1200) comprises output circuitry (1250) (for example, a CPU, GPU, I/O bridge or other suitable means of outputting image data) configured (again for example by suitable software instruction) to output the processed image, as described elsewhere herein.

It will be appreciated that the above apparatus 1200, operating under suitable software instruction, may implement the methods and techniques described herein.

Furthermore, it will be appreciated that with reference to FIG. 12, hardware for training purposes only does not need to include the image processing circuitry 1240 or the output circuitry 1250, and meanwhile hardware for prediction purposes only does not need to contain input circuitry 1220.

Similarly it will be appreciated that respective circuitry of the apparatus may optionally be distributed over several discrete devices. For example, training (and/or training refinement) may occur on a remote server, whilst use of the trained machine learning system may occur on a separate server (e.g. serving broadcast/streamed content) or on a client device such as a PC or videogame console.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An image processing method, comprising the steps of:
inputting data representative of an image (1300, 1350) into a machine learning system 1230, the machine learning system having been previously trained to predict a gaze position of viewers of images;
obtaining a predicted gaze position from the machine learning system in response to the input data;
performing predicted gaze position dependent image processing, the image processing producing at least a first region (1310) of the image corresponding to where a viewer is predicted to gaze, and a second region (1320, 1370), with a first image quality of the first region being higher than a second image quality of the second region; and
outputting the processed image; wherein
the first region is defined responsive to a probability of viewer gaze at locations within the image, output by the machine learning system, exceeding a predetermined first threshold,
the image processing generates an image according to a data size budget for the image, and
the first threshold is adjusted responsive to the data size budget for the image.

2. An image processing method according to claim 1 which the image processing produces a transition region (1360), with an image quality between the first image quality and the second image quality.

3. An image processing method according to claim 1, in which the image processing performs additive quality improvement and/or subtractive quality reduction to respective regions of the image.

4. An image processing method according to claim 3, in which the image processing performs one or more:
i. foveated rendering in at least parts of the first region;
ii. image post-processing in at least parts of the first region;
iii. differentiated compression, with greater compression in at least parts of the second region than the first region; and
iv. decimation in at least parts of the second region.

5. An image processing method according to claim 1, wherein:
at least a first transition region is defined responsive to a probability of viewer gaze at locations within the image, output by the machine learning system, exceeding a predetermined respective threshold lower than the predetermined first threshold, and
if a plurality of transition regions are defined using a hierarchy of thresholds, the resulting hierarchy of different transition regions have an associated hierarchy of image qualities, with higher thresholds corresponding to higher qualities.

6. An image processing method according to claim 1, in which the image processing produces one or more of:
i. a plurality of first regions; and
ii. a plurality of transitional regions.

7. An image processing method according to claim 1, in which the machine learning system is selected from amongst a plurality of machine learning systems each trained using one or more of:
i. data representative of images from a respective type of content as inputs; and
ii. data representative of gaze positions for a respective viewer demographic as targets.

8. An image processing method according to claim 1, in which the data representative of an image comprises one or more of:
i. a colour normalised image;
ii. a resolution normalised image;
iii. at least part of a Fourier transform of at least part of the image or a derivative image thereof;
iv. difference data for at least part of the image or a derivative image thereof and a proceeding corresponding image;
v. at least some motion vectors associated with the image; and
vi. data representative of sound occurring within a predefined window centred on the occurrence of the image within a sequence of images having associated sound.

9. An image processing method according to claim 1, comprising the steps of
tracking the gaze of a viewer of the output processed image; and
supplying gaze data representative of the gaze of the viewer back to the machine learning model in conjunction with the corresponding input image to refine the training of the model.

10. A image processing method according to claim 1, comprising the steps of:
tracking the gaze of a viewer of the output processed image; and
if the gaze of the viewer is directed to the second region of the output processed image for a predetermined period of time, then processing is performed to improve the effective quality of the second region for one or more subsequent images.

11. An image processing method according claim 1, in which the image (1300, 1350) is part of a pre-recorded or live video being streamed or broadcast.

12. An image processing method according to claim 1, wherein:
the image is part of a videogame; and
the predicted gaze position dependent image processing comprises selecting a level of detail for the first region; and
accessing corresponding geometry data for the selected level of detail prior to rendering of a subsequent image.

13. A non-transitory, computer readable storage medium containing a computer program comprising computer executable instructions adapted to cause a computer system to perform an image processing method by carrying out actions, comprising:
inputting data representative of an image (1300, 1350) into a machine learning system 1230, the machine learning system having been previously trained to predict a gaze position of viewers of images;
obtaining a predicted gaze position from the machine learning system in response to the input data;
performing predicted gaze position dependent image processing, the image processing producing at least a first region (1310) of the image corresponding to where a viewer is predicted to gaze, and a second region (1320, 1370), with a first image quality of the first region being higher than a second image quality of the second region; and
outputting the processed image; wherein
the first region is defined responsive to a probability of viewer gaze at locations within the image, output by the machine learning system, exceeding a predetermined first threshold,
the image processing generates an image according to a data size budget for the image, and
the first threshold is adjusted responsive to the data size budget for the image.

14. An image processing apparatus (1200), comprising:
a machine learning system (1230) configured to obtain a predicted gaze position in response to the input data, the machine learning system having been previously trained to predict the gaze position of viewers of images;
processing circuitry (1210) configured to input data representative of an image (1300, 1350) into the machine learning system 1230;
image processing circuitry (1240) configured to perform predicted gaze position dependent image processing, the image processing producing at least a first region (1310) of the image corresponding to where a viewer is predicted to gaze, and a second region (1320, 1370), with a first image quality of the first region being higher than a second image quality of the second region; and
output circuitry (1250) configured to output the processed image; wherein
the first region is defined responsive to a probability of viewer gaze at locations within the image, output by the machine learning system, exceeding a predetermined first threshold,
the image processing circuitry generates an image according to a data size budget for the image, and
the first threshold is adjusted responsive to the data size budget for the image.
